(19) United States
(12) Patent Application Publication
(10) Pub. No.: US 2020/0179944 A1
(43) Pub. Date: Jun. 11, 2020

(54) SLANT TYPE MAGNETIC SEPARATOR

(71) Applicant: Korea Separation Co., Ltd., Gangwon-Do (KR)

(72) Inventors: Mi-ae KIM, Gangwon-Do (KR); Won-woo SONG, Gangwon-Do (KR)

(73) Assignee: Korea Separation Co., Ltd.

(21) Appl. No.: 16/684,813

(22) Filed: Nov. 15, 2019

(30) Foreign Application Priority Data
Dec. 11, 2018 (KR) 10-2018-0159066

(51) Int. Cl. B03C 1/22

(52) U.S. Cl. CPC B03C 1/22; B03C 2201/20

(57) ABSTRACT

Provided is a slant type magnetic separator including: a belt conveyor including a pair of conveying rollers and a belt wound around the conveying rollers in a caterpillar manner; first and second slant adjustment units adjusting slants of the belt conveyor. The slant type magnetic separator further includes: separated material discharge units separating and discharging materials to two sides and a lower end of the belt conveyor according to a magnitude of magnetism and a weight of the materials; a cleaning unit spraying washing water toward a surface of the belt conveyor; and scrapers pushing magnetically attached materials magnetically attached to the surface of the belt conveyor in the conveying direction of the belt conveyor. Accordingly, it is possible to consciously effectively separate and recover a large amount of weakly magnetic materials contained in a large amount of fly ash, sand, or the like having large processing capacity.

### CROSS-REFERENCE TO RELATED PATENT APPLICATION

This application claims the benefit of Korean Patent Application No. 10-2018-0159066, filed on Dec. 11, 2018, in the Korean Intellectual Property Office, the disclosure of which is incorporated herein by reference in its entirety by reference.

### FIELD

The present invention relates to a magnetic separator, and more particularly, to a slant type magnetic separator that can separate and recover weak magnetic materials or paramagnetic materials attracted to magnets from non-magnetic materials.

### BACKGROUND

Magnetic separators are classified into dry magnetic separators and wet magnetic separators according to whether water is used. In addition, the magnetic separators are classified into a permanent magnet type and an electromagnet type according to the type of used magnets.

In general, as the dry magnetic separators, there are a cross-belt type where, while a separation object is moved by a belt conveyor disposed horizontally, magnetically attached materials are separated by magnets disposed to be spaced in a predetermined distance on the upper side and a type where, while a separation object conveyed by a belt conveyor is allowed to pass through a magnetic drum, magnetic materials are separated and recovered.

The wet-magnetic separator has a structure of allowing a sample in a form of slurry mixed with water to be in contact with magnetic drum to attach and recover magnetic materials.

These magnetic separators are effective to separate particles having a size of about 0.1 mm or more, but there is a problem in that these magnetic separators cannot sufficiently effectively separate particles having a size of less than about 0.1 mm.

For example, in the case of separating a separation object as a mixture of fine particles by using the dry magnetic separator, a large amount of the non-magnetic fine particles are mixed into the magnetically attached materials, and thus, the separation efficiency is deteriorated.

In the case of using the wet magnetic separator in order to solve the problem, since a very high magnetic force of about 10,000 gauss or more is required to reliably separate weak magnetic materials, high gradient magnetic separators of the electromagnet type have been used.

However, the high gradient magnetic separators of the electromagnet type have a structural problem in that the separation range where the high magnetic force is applied is narrow. The high gradient magnetic separators of the electromagnet type are useful for removing an extremely small amount iron components contained in food raw materials or white pigments. However, the high gradient magnetic separators of the electromagnet type are not suitable as separators for recovering a large amount of iron components contained in a large amount of such a selection object as fly ash containing iron oxide or the like or sand containing a rare earth mineral monazite, which has a property of being weakly attracted to magnets.

As a cited document, there is Korea Patent Publication No. 10-1579612 (published at Dec. 22, 2015)

### SUMMARY

The present invention is to provide a slant type magnetic separator which can consciously effectively separate and recover a large amount of weakly magnetic materials contained in a large amount of fly ash, sand, or the like having large processing capacity

According to an aspect of the invention, there is provided a slant type magnetic separator separating and recovering magnetic materials contained in fly ash or sand, the slant type magnetic separator including: a belt conveyor including a pair of conveying rollers and a belt wound around the conveying rollers in a caterpillar manner; a support frame supporting a lower portion of the belt conveyor; magnet members provided on a rear side of the belt conveyor, each of the magnetic members including a pair of permanent magnets of which the same poles face each other and a pure iron plate disposed between the permanent magnets; a belt frame hinge-coupled to the support frame in a state of being disposed between the belt of the belt conveyor, rotatably supporting the conveying roller, and including the plurality of magnet members disposed to be spaced in a zigzag manner horizontally and vertically along a conveying direction of the belt conveyor; a first slant adjustment unit adjusting a slant between the support frame and the belt conveyor so that the belt conveyor is slanted in a direction perpendicular to the conveying direction of the belt conveyor; a second slant adjustment unit adjusting a slant of the support frame so that the support frame is slanted upward in the conveying direction of the belt conveyor; a sample inlet provided in a form of a hopper above the magnet members disposed in a first row of a rear end of the belt conveyor, a sample mixture in a form of slurry mixed with water being input to the sample inlet; a separated material discharge unit including a first discharge unit to which non-magnetic light-weighted separated materials are discharged in a rear end side of the belt conveyor, a second discharge unit to which non-magnetic heavy-weighted separated materials are discharged in a rear end lower portion of the belt conveyor, a third discharge unit to which magnetic light-weighted separated materials are discharged in a front end lower portion of the belt conveyor, and a fourth discharge unit to which ferromagnetic separated materials or magnetic heavy-weighted separated materials are discharged in a front end side of the belt conveyor; a cleaning unit provided at an upper portion of the belt conveyor, a cleaning unit including a feed pipe disposed to be horizontally elongated in front of the sample inlet to feed washing water and a plurality of spray nozzles provided to the feed pipe to be spaced in a longitudinal direction of the feed pipe to spray the washing water toward a surface of the belt of the belt conveyor; and scrapers provided on the surface of the belt of the belt conveyor at positions facing the magnet members to pass through the centers of the magnet members disposed in series in front of the sample inlet, the scrapers pushing magnetically attached materials magnetically attached to the surface of the belt of the belt conveyor by a magnetic force of the magnetic members in the conveying direction of the belt conveyor.

In the above aspect, the belt frame includes: the magnet members, each of the magnetic members including the pair of permanent magnets of which the same poles face each other and the pure iron plate disposed between the permanent magnets; a first panel where grooves are formed to be spaced in the conveying direction of the belt conveyor and the magnet members are inserted into the grooves; and second panels respectively coupled to upper and lower surfaces of the first panel.

In the above aspect, the first slant adjustment unit includes: a coupling arm formed extend to one side of the support frame; a slant adjustment shaft where a screw thread is formed along a longitudinal direction on an outer periphery of the slant adjustment shaft, a lower portion of the slant adjustment shaft is screw-coupled to the shaft coupling nut provided on the coupling arm, and an upper portion of the slant adjustment shaft is supported on the belt frame; and a slant adjustment handle coupled to an upper portion of the slant adjustment shaft.

In the above aspect, the slant type magnetic separator further includes a base frame on which the support frame is mounted and which is hinge-coupled to the support frame, wherein the second slant adjustment unit includes: a slant adjustment shaft where a screw thread is formed along a longitudinal direction on an outer periphery of the slant adjustment shaft, a lower portion of the slant adjustment shaft is screw-coupled to the shaft coupling nut provided on the base frame, and an upper portion of the slant adjustment shaft is supported on the support frame; and a slant adjustment handle coupled to a lower portion of the slant adjustment shaft.

In the above aspect, the sample inlet and the separated material discharge unit are provided on a rear end side of the belt conveyor, the sample mixture in a form of slurry mixed with water is input to the sample inlet, and the separated material discharge unit includes a first discharge unit discharging separated materials to the rear end of the belt conveyor, second and third discharge units discharging separated materials to respective sides of the belt conveyor, and a fourth discharge unit discharging separated materials to a front end of the belt conveyor.

In the above aspect, the cleaning unit is provided on one side of the belt conveyor in the conveying direction of the belt conveyor, and the cleaning unit includes the feed pipe feeding the washing water and the spray nozzles provided to the feed pipe to be spaced in a longitudinal direction of the feed pipe to spray the washing water toward the surface of the belt of the belt conveyor.

In the above aspect, the scrapers are provided on the surface of the belt of the belt conveyor, and the scrapers push the magnetically attached materials magnetically attached to the surface of the belt of the belt conveyor by the magnetic force of the magnetic members in the conveying direction of the belt conveyor.

According to the invention, by concentrating powerful rare-earth permanent magnets to minimize a distance between a separation object and the magnets and maximize the contact area in a state where a flux density is maximized, weakly magnetic materials which cannot be separated by existing drum type separators can be attached to the magnets to be recovered, and due to an open planar structure capable of maximizing an input speed of the selection sample, the short comings of the high gradient magnetic separator in the related art can be complemented.

Accordingly, the application field of the magnetic separator according to the invention is expected to be extended to the field where economic feasibility is low due to lower separation efficiency or high separation costs in the related art as well as the magnetic separation field using the drum type magnetic separators and the high gradient magnetic separators in the related art.

### BRIEF DESCRIPTION OF THE DRAWINGS

The invention will be better understood and objects other than those set forth above will become apparent when consideration is given to the following detailed description thereof. Such description makes reference to the accompanying drawings wherein:

FIG. 1 is a perspective view illustrating a slant type magnetic separator according to an embodiment of the invention;

FIGS. 2 and 3 are side views illustrating the slant type magnetic separator according to the embodiment of the invention;

FIG. 4 is a front view illustrating the slant type magnetic separator according to the embodiment of the invention;

FIG. 5 is a bottom perspective view illustrating the slant type magnetic separator according to the embodiment of the invention;

FIG. 6 is an exploded perspective view with a partial enlarged view illustrating the slant type magnetic separator according to the embodiment of the invention; and

FIG. 7 is an exemplary view illustrating an operation state of the slant type magnetic separator according to the embodiment of the invention.

### DETAILED DESCRIPTION

Hereinafter, a slant type magnetic separator according to an embodiment of the invention will be described with reference to the accompanying drawings.

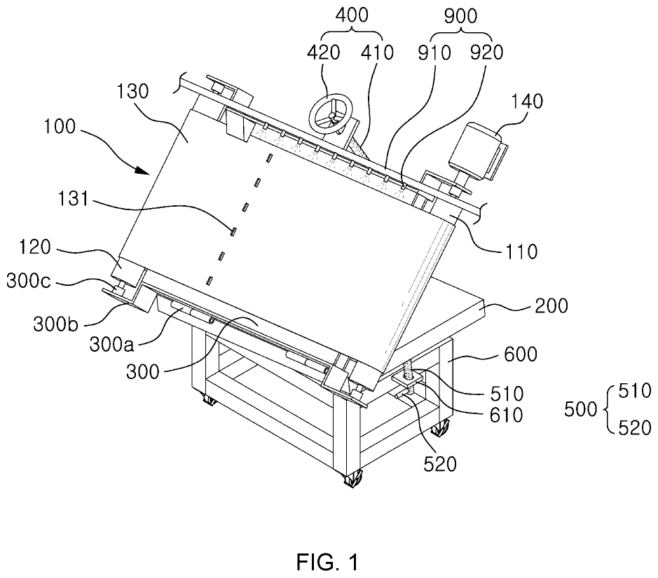

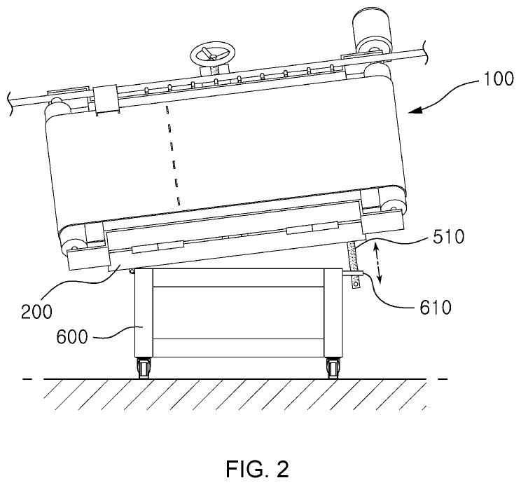

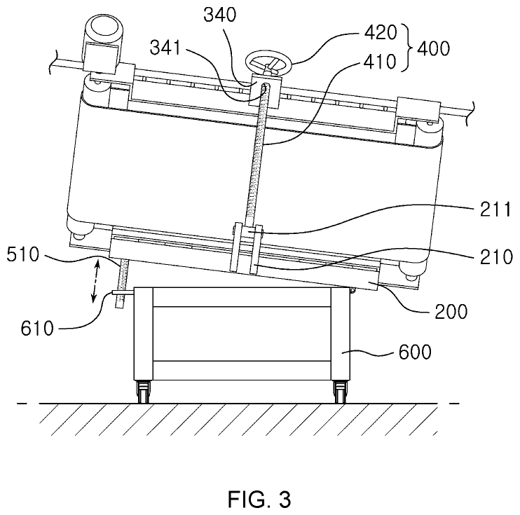

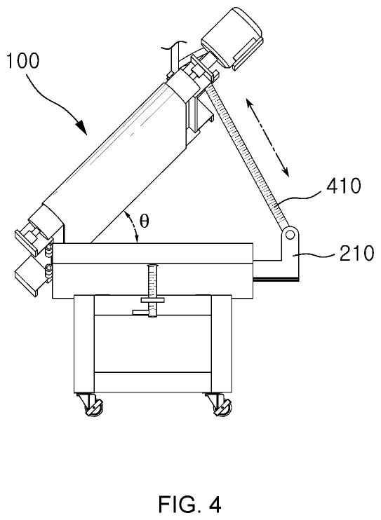

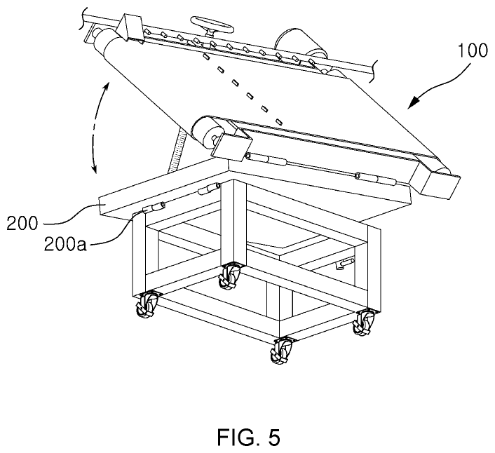

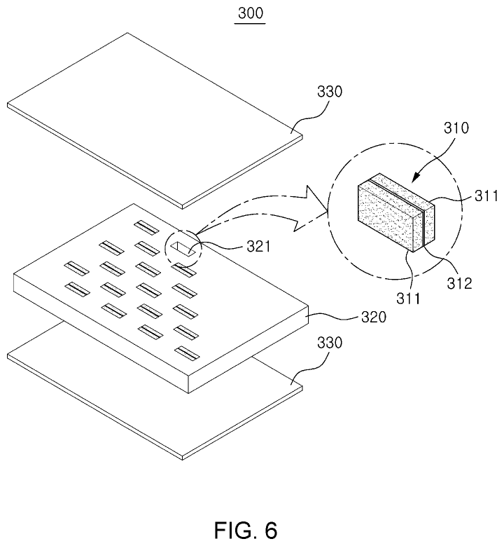

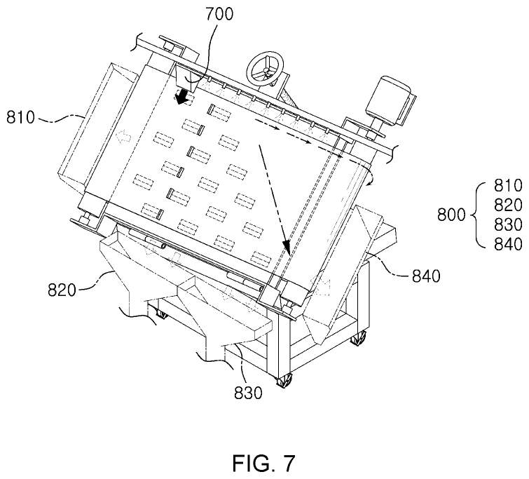

FIG. 1 is a perspective view of the slant type magnetic separator according to the embodiment of the invention, FIGS. 2 and 3 is side views illustrating the slant type magnetic separator, FIG. 4 is a front view illustrating the slant type magnetic separator, FIG. 5 is a bottom perspective view illustrating the slant type magnetic separator, FIG. 6 is an exploded perspective view with an partial enlarged view illustrating the slant type magnetic separator, and FIG. 7 is an exemplary view illustrating an operation state of the slant type magnetic separator.

Referring to FIGS. 1 to 7, the slant type magnetic separator according to the embodiment of the invention includes a belt conveyor 100, a support frame 200, a belt frame 300, a first slant adjustment unit 400, and a second slant adjustment unit 500. These configuration components will be described in detail as follows.

The belt conveyor 100 includes a pair conveying rollers 110 and 120 and a belt 130 wound in a caterpillar around the conveying rollers 110 and 120. Herein, the conveying rollers 110 and 120 are configured as a driving roller 110 which is coupled with a driving motor 140 to rotate with a rotating force of driving motor 140 received and a driven roller 120, respectively. The belt 130 is wound around the conveying rollers 110 and 120 configured as the driving roller 110 and the driven roller 120 in a caterpillar manner.

At this time, the specification of the driving motor 140 for driving the driving roller 110 depends on the size of the separator, and in a case where the area of the belt frame 300 is 1 m², it is preferable that a 1/2 HP geared motor having a reduction ratio of 1/2 is applied.

The support frame 200 is positioned below the belt conveyor 100 to support the belt conveyor 100.

The belt frame 300 is hinge-coupled to the support frame 200, in a state where the belt 130 of the belt conveyor 100 is disposed, to rotatably support the conveyor rollers 110 and 120, and a plurality of magnet members 310 are spaced and disposed along the conveying direction of the belt conveyor 100.

In other words, the belt frame 300 rotatably supports the pair of conveying rollers 110 and 120 so that the belt conveyor 100 has a slant angle with respect to the support frame 200. The support frame 200 is coupled to the belt frame 300 by using a hinge 300a.

The hinge 300a is disposed in a direction opposite to the first slant adjustment unit 400, so that the slant angle can be adjusted by allowing the belt conveyor 100 to rotate about the hinge 300a.

Herein, the belt frame 300 is formed in a plate-like shape, and the conveyor rollers 110 and 120 are rotatably disposed on both sides thereof. The rotation shafts of the pair of conveying rollers 110 and 120 are coupled to roller coupling arms 300b of the support frame 200 with bearings 300c. In addition, a plurality of magnet members 310 are spaced in a predetermined interval and coupled to the belt frame 300.

Then, a shaft insertion plate 340 into which a slant adjustment shaft 410 is inserted is formed to extend on one side of the belt frame 300. An insertion hole 341 into which the slant adjustment shaft 410 is inserted is formed on the shaft insertion plate 340, and thus, the shaft insertion plate 340 is moved upward and downward along the slant adjustment shaft 410 in a state of being inserted into the insertion hole 341.

On the other hand, the belt frame 300 is configured to include magnet members 310, a first panel 320, and second panels 330.

The magnet members 310 are disposed inside the belt frame 300 to apply a magnetic force to the belt 130 of the belt conveyor 100. Due to the magnetic members 310, the magnetic force is applied to the sample mixture being moved along the upper surface of the belt 130, so that the sample mixture is separated into the magnetic materials and non-magnetic materials.

Herein, the magnet member 310 is configured with a pair of permanent magnets 311 of which the same poles face each other and a pure iron plate 312 disposed between the permanent magnet 311.

The first panel 320 is configured so that grooves 321 are formed to be spaced in the conveying direction of the belt conveyor 100, and the magnet members 310 are provided to be inserted into the grooves 321. Then, the second panels 330 are respectively coupled to the upper and lower surfaces of the first panel 320.

The first panel 320 has a plate-like shape made of a material having a high hardness and not being easily deformed such as an epoxy resin, and it is preferable that the thickness of the first panel 320 is equal to the thickness of the magnet member 310.

According to the embodiment of the invention, two neodymium magnets having a magnetic flux density of about 5,000 gauss are disposed with the same poles facing each other, and a pure iron plate 312 having a thickness of about 1 mm is sandwiched therebetween.

In this case, the lines of magnetic force are concentrated on the pure iron plate 312, and a strong line of magnetic force having a magnetic density of about 10,000 to 14,000 gauss is formed.

The horizontal and vertical distances between the grooves 321 formed in the first panel 320 are adjusted in a range of about 1 to 10 cm, and it is preferable that the horizontal distance is about 5 cm, and the vertical distance is about 10 cm.

If the distances between the grooves are closer than these distances, the number of required magnets is increased, so that the production cost becomes increased, and the possibility that the non-magnetic materials inserted between the magnetic materials are departed is lowered, so that the separation efficiency is deteriorated. On the contrary, if the distance between the grooves 321 is longer than these distances, the number of required magnets is decreased, but the number of repetitions of attachment, dispersion, attachment, and dispersion is decreased, so that there is a problem that the purity of separated materials is lowered.

Then, the second panel 330 serves to prevent the detachment and the wear and corrosion of the magnet members 310 and is made of corrosion-resistant, wire-resistant plate material. It is preferable that the second panel 330 is made of an SUS-304 plate material having a thickness of about 1 mm.

On the other hand, the magnet members 310 are disposed in a longitudinal direction along the conveying direction of the belt conveyor 100. The magnet members 310 may be formed with the same length or with different lengths. In a case where the magnet members 310 are formed with different lengths, the magnet members 310 are disposed so that the lengths gradually increases as it goes from a location away from the hinge 300a to a location close to the hinge 300a. This is because, since the height of the location away from the hinge 300a is larger than the height of the location close to the hinge 300a, the magnetic members which are to be moved downward by gravity in addition to the magnetic force are to be within the range of the magnetic force.

The first slant adjustment unit 400 serves to adjust the slant angle between the support frame 200 and the belt conveyor 100 so that the belt conveyor 100 is slanted with respect to the direction perpendicular to the conveying direction of the belt conveyor 100.

The first slant adjustment unit 400 is provided with a slant adjustment shaft 410 and slant adjustment handle 420.

In other words, the support frame 200 is coupled to the belt frame 300 by using the hinge 300a. The belt frame 300 is supported so as to be slanted at a predetermined angle from the support frame 200 by using the hinge 300a. The one end of the belt frame 300 is coupled to the support frame 200 by using the hinge 300a, and the other end thereof is coupled to the first slant adjustment unit 400, so that the height is adjusted.

At this time, a coupling arm 210 for fixing the lower portion of the slant adjustment shaft 410 of the first slant adjustment unit 400 is formed on one side of the support frame 200 to project. The coupling arm 210 is bent in a shape of “L”. The coupling arm 210 is formed so that the height thereof corresponds to the height of the belt conveyor 100.

The upper portion of the coupling arm 210 is provided with a shaft coupling nut 211. A screw thread is formed in the inner peripheral surface of the shaft coupling nut 211. The lower portion of the slant adjustment shaft 410 is screw-coupled to the shaft coupling nut 211, so that the vertical height of the slant adjustment shaft 410 is adjusted. The slant angle of the belt conveyor 100 is adjusted in accordance with the length of the slant adjustment shaft 410 which is positioned at the upper portion of the shaft coupling nut 211.

The first slant adjustment unit 400 adjusts the slant angle so that the belt conveyor 100 is slanted with respect to a direction perpendicular to the conveying direction. The first slant adjustment unit 400 includes the slant adjustment shaft 410 screw-coupled to the shaft coupling nut 211 and the slant adjustment handle 420 coupled to the upper portion of the slant adjustment shaft 410 to be operated by an operator.

The slant adjustment shaft 410 is inserted through the shaft insertion plate 340, and after that, the slant adjustment shaft 410 is screw-coupled to the shaft coupling nut 211. The top of the slant adjustment shaft 410 exposed to the upper portion of the shaft insertion plate 340 is provided with the slant adjustment handle 420. A screw thread is formed along the longitudinal direction on the outer periphery of the slant adjustment shaft 410. The slant adjustment shaft 410 and the shaft coupling nuts 211 are screw-coupled to each other. When the operator rotates the slant adjustment handle 420 in normal and reverse directions, the slant adjustment shaft 410 is moved upward and downward relative to the shaft coupling nut 211, respectively. Accordingly, the slant angle of the belt conveyor 100 can be adjusted.

As the slant angle becomes smaller, the non-magnetic materials are less influenced by gravity, and thus, the non-magnetic materials cannot be easily separated. On the other hand, as the slant angle becomes larger, the non-magnetic materials are greatly influenced by gravity, and the non-magnetic materials can be easily separated. However, since the magnetic materials are also influenced by gravity, the magnetic materials cannot also be easily separated.

Accordingly, the slant angle is preferably determined in consideration of the conveying rate of the belt conveyor 100, the amount of the sample mixture, the content of the magnetic materials contained in the sample mixture, and the like.

The second slant adjustment unit 500 servers to adjust the slant angle of the support frame 200 so that the belt conveyor 100 is slanted upward in the conveying direction of the belt conveyor 100.

In this case, the slant type magnetic separator according to the invention further includes a base frame 600 on which the support frame 200 is mounted and which is hinge-coupled to the support frame 200.

Then, the support frame 200 is coupled to the base frame 600 by using a hinge 200a.

The hinge 200a is disposed in a direction opposite to the second adjustment unit 500, and thus, the support frame 200 is rotated about the hinge 200a, so that the slant angle can be adjusted.

The second slant adjustment unit 500 is provided with a slant adjustment shaft 510 and a slant adjustment handle 520.

The slant adjustment shaft 510 has a screw thread formed in the longitudinal direction on the outer periphery, the lower portion is screw-coupled to the shaft coupling nut 610 provided on the base frame 600, and the upper portion is supported by the support frame 200.

Then, the slant adjustment handle 520 is coupled to the lower portion of the slant adjustment shaft 510.

The slant adjustment shaft 510 is screw-coupled to the shaft coupling nut 610. The lower portion of the slant adjustment shaft 510 is provided with the slant adjustment handle 520. The outer periphery of the slant adjustment shaft 510 has a screw thread is formed along in the longitudinal direction. The slant adjustment shaft 510 and the shaft coupling nuts 610 are screw-coupled to each other. When the operator rotates the slant adjustment handle 520 in normal and reverse directions, the slant adjustment shaft 510 is moved upward and downward relative to the shaft coupling nut 610, respectively. Accordingly, the slant angle of the support frame 200 can be adjusted.

On the other hand, the slant type magnetic separator according to the invention further includes a sample inlet 700 and a separated material discharge unit 800.

The sample inlet 700 is provided at the rear end side of the belt conveyor 100, and the sample mixture in a form of slurry mixed with water is input.

The separated material discharge unit 800 includes a first discharge unit 810 which discharges separated materials to the rear end of the belt conveyor 100, second and third discharge units 820 and 830 which discharge separated materials to respective sides of the belt conveyor 100, and a fourth discharge unit 840 which discharges separated materials to the front end of the belt conveyor 100.

In order words, non-magnetic light-weighted materials are discharged to the first discharge unit 810, non-magnetic heavy-weighted materials are discharged to the second discharge unit 820, magnetic light-weighted materials are discharged to the third discharge unit 830, and ferromagnetic materials or magnetic heavy-weighted materials are discharged to the fourth discharge unit 840.

Then, the slant type magnetic separator according to the invention may be configured to further include a cleaning unit 900 provided with a feed pipe 910 and spray nozzles 920.

The feed pipe 910 is provided on one side of the belt conveyor 100 in the conveying direction of the belt conveyor 100 and washing water is fed through the feed pipe 910.

The spray nozzles 920 are disposed to the feed pipe 910 and spaced apart in the longitudinal direction of the feed pipe 910 and spray the washing water toward the surface of the belt 130 of the belt conveyor 100 in a spray form.

In addition, a shut-off valve (not illustrated) may be further provided along the feed pipe 910 to control the washing water sprayed through the respective spray nozzle 920, so that the amount of washing water sprayed toward the belt conveyor 100 can be adjusted.

In addition, the slant type magnetic separator according to the invention may be configured to further include scrapers 131 which are disposed on the surface of the belt 130 of the belt conveyor 100 to push the magnetically attached materials, which are magnetically attached to the surface of the belt 130 of the belt conveyor 100 by the magnetic force of the magnet members 310, in the conveying direction of the belt conveyor 100.

The scrapers 131 in use of pushing the magnetically attached materials are provided on the surface of the belt 130 of the belt conveyor 100. It is preferable that the material of the scrapers 131 are made of a rubber or plastic, and the scrapers 131 are provided at positions facing the magnet members 310 to pass through the centers of the magnet members 310.

According to one embodiment, when the sample mixture of water, magnetic materials, and non-magnetic materials is allowed to flow from the sample inlet 700, the non-magnetic materials tend to be moved toward the first discharge unit 810 and the second discharge units 820 due to the influence of the flow of water, and the magnetic materials tend to be moved toward the third discharge unit 830 and the fourth discharge unit 840, so that the magnetic materials and the non-magnetic materials can be separated from each other.

That is, the non-magnetic materials trapped between the magnetic materials are attached to the magnet member 310 of the upper first row of the belt frame 300. Then, when the non-magnetic materials trapped between the magnetic materials are moved by the scrapers 131 in the conveying direction of the belt conveyor 100, the non-magnetic materials trapped between the magnetic materials are detached from the magnet member 310 and are diffused to be moved downward by the washing water flowing from the top. On the other hand, the magnetic materials are attached to the magnet member 310 of the lower second row or lest side of the belt frame 300, and the non-magnetic materials are moved toward the second discharge unit 820 due to the flow of the water.

By the repetition of this movement, the magnetic materials are moved in the conveying direction of the belt conveyor 100, and the non-magnetic materials are moved in the direction opposite to the conveying direction or the vertical direction of the conveying direction of the belt conveyor 100, so that the magnetic materials and the non-magnetic materials can be separated from each other.

Hereinafter, the slant type magnetic separator according to the invention will be described with reference to an experimental example.

### Experimental Example

In the magnetic separator manufactured with the belt frame 300 where the magnet members 310 are disposed to have a horizontal distance of 5 cm and a vertical distance of 10 cm, the slant angle of the belt conveyor 100 in the conveying direction of the belt 130 is raised by 3° by manipulating the second slant adjustment unit 500, and the slant angle of the belt conveyor 100 in the lateral direction is raised by 10° by manipulating the first slant adjustment unit 400.

Next, in a state where the conveying speed of the belt conveyor 100 is set to about 20 cm/s, 1 kg mixture of particles of 20% Fe₃O₄, 30% SiO₂, 25% CaSO₄-2H₂O, and 25% Ca(OH)₂ with particle sizes of about 45 μm or less is mixed with about 99 liters of water. Next, while the mixture is input to the sample inlet 700 at a rate of about 1 L/min, the flow rate of the entire washing water is set to about 3 L/min. As a result, under the condition, about 92% of the input Fe₃O₄ is recovered from the third discharge unit 830 and the fourth discharge unit 840, and the purity thereof is about 95%.

While the invention has been particularly illustrated and described with reference to exemplary embodiments thereof, it should be understood by the skilled in the art that the invention is not limited to the disclosed embodiments, but various modifications and applications not illustrated in the above description can be made without departing from the spirit of the invention. In addition, differences relating to the modifications and applications should be construed as being included within the scope of the invention as set forth in the appended claims.

What is claimed is:

1. A slant type magnetic separator separating and recovering magnetic materials contained in fly ash or sand, the slant type magnetic separator comprising:
a belt conveyor including a pair of conveying rollers and a belt wound around the conveying rollers in a caterpillar manner;
a support frame supporting a lower portion of the belt conveyor;
magnet members provided on a rear side of the belt conveyor, each of the magnetic members including a pair of permanent magnets of which the same poles face each other and a pure iron plate disposed between the permanent magnets;
a belt frame hinge-coupled to the support frame in a state of being disposed between the belt of the belt conveyor, rotatably supporting the conveying rollers, and including the plurality of magnet members disposed to be spaced in a zigzag manner horizontally and vertically along a conveying direction of the belt conveyor;
a first slant adjustment unit adjusting a slant between the support frame and the belt conveyor so that the belt conveyor is slanted in a direction perpendicular to the conveying direction of the belt conveyor;
a second slant adjustment unit adjusting a slant of the support frame so that the support frame is slanted upward in the conveying direction of the belt conveyor;
a sample inlet provided in a form of a hopper above the magnet members disposed in a first row of a rear end of the belt conveyor, a sample mixture in a form of slurry mixed with water being input to the sample inlet;
a separated material discharge unit including a first discharge unit to which non-magnetic light-weighted separated materials are discharged in a rear end side of the belt conveyor, a second discharge unit to which non-magnetic heavy-weighted separated materials are discharged in a rear end lower portion of the belt conveyor, a third discharge unit to which magnetic light-weighted separated materials are discharged in a front end lower portion of the belt conveyor, and a fourth discharge unit to which ferromagnetic separated materials or magnetic heavy-weighted separated materials are discharged in a front end side of the belt conveyor;
a cleaning unit provided at an upper portion of the belt conveyor, a cleaning unit including a feed pipe disposed to be horizontally elongated in front of the sample inlet to feed washing water and a plurality of spray nozzles provided to the feed pipe to be spaced in a longitudinal direction of the feed pipe to spray the washing water toward a surface of the belt of the belt conveyor; and
scrapers provided on the surface of the belt of the belt conveyor at positions facing the magnet members to pass through the centers of the magnet members disposed in series in front of the sample inlet, the scrapers pushing magnetically attached materials magnetically attached to the surface of the belt of the belt conveyor by a magnetic force of the magnetic members in the conveying direction of the belt conveyor.

2. The slant type magnetic separator according to claim 1, wherein the belt frame includes:
the magnet members, each of the magnetic members including the pair of permanent magnets of which the same poles face each other and the pure iron plate disposed between the permanent magnets;
a first panel where grooves are formed to be spaced in the conveying direction of the belt conveyor and the magnet members are inserted into the grooves; and
second panels respectively coupled to upper and lower surfaces of the first panel.

3. The slant type magnetic separator according to claim 1, wherein the first slant adjustment unit includes:
a coupling arm formed extend to one side of the support frame;
a slant adjustment shaft where a screw thread is formed along a longitudinal direction on an outer periphery of the slant adjustment shaft, a lower portion of the slant adjustment shaft is screw-coupled to the shaft coupling nut provided on the coupling arm, and an upper portion of the slant adjustment shaft is supported on the belt frame; and
a slant adjustment handle coupled to an upper portion of the slant adjustment shaft.

4. The slant type magnetic separator according to claim 1, further comprising a base frame on which the support frame is mounted and which is hinge-coupled to the support frame,
wherein the second slant adjustment unit includes:
a slant adjustment shaft where a screw thread is formed along a longitudinal direction on an outer periphery of the slant adjustment shaft, a lower portion of the slant adjustment shaft is screw-coupled to the shaft coupling nut provided on the base frame, and an upper portion of the slant adjustment shaft is supported on the support frame; and
a slant adjustment handle coupled to a lower portion of the slant adjustment shaft.
